(19) United States
(12) Patent Application Publication
(10) Pub. No.: US 2023/0241705 A1
(43) Pub. Date: Aug. 3, 2023

(54) METHOD AND DEVICE FOR IMPACT WELDING OF BATTERY TERMINALS

(71) Applicant: GM Global Technology Operations LLC, Detroit, MI (US)

(72) Inventors: Wayne Cai, Troy, MI (US); Teresa Jean Rinker, Royal Oak, MI (US); Jennifer Therese Bracey, Holly, MI (US); Shunyi Zhang, Troy, MI (US)

(21) Appl. No.: 17/587,132

(22) Filed: Jan. 28, 2022

(51) Int. Cl. B23K 11/04; H01M 50/566; H01M 10/0525

(52) U.S. Cl. CPC B23K 11/04; H01M 50/566; H01M 10/0525

(57) ABSTRACT

A method comprises deforming one or more metal foils of a battery between a punch and a die to form bent metal foils. The one or more bent metal foils are disposed in a foil holding fixture with a battery lead disposed next to the one or more bent metal foils such that a bent portion of the one or more bent metal foils are separated from the battery lead by a distance of 0.1 to 2 millimeters. The one or more bent metal foils are impact welded by causing the foils to impact one another or to impact a battery lead at a velocity of speeds of 300 to 900 meters per second.

### INTRODUCTION

Disclosed herein is a method and device for impact welding of battery terminals. More specifically, disclosed herein is a method and a device for impact welding of metals, including dissimilar metals, to improve weld quality.

Lithium ion battery packs for vehicle and other high-power applications may include multiple lithium ion battery cells that are electrically connected together. Each cell includes a plurality of lithium ion electrode pairs that are enclosed within a sealed pouch envelope. Each electrode pair includes a negative electrode, a positive electrode, and a separator that physically separates and electrically isolates the negative and positive electrodes. To facilitate lithium ion mobility, an electrolyte that conducts lithium ions may be present. The electrolyte allows lithium ions to pass through the separator between the positive and negative electrodes during charge and discharge cycles of the lithium ion battery cell.

Depending on their chemistry, each lithium ion battery cell has a maximum or charging voltage (voltage at full charge) due to the difference in electrochemical potentials of the electrodes. For example, each lithium ion battery cell may have a charging voltage in the range of 3V to 5V and a nominal open circuit voltage in the range of 3.5V to 4.5V. Lithium ion battery cells may be connected in series, in parallel, or in series and in parallel depending on the specified battery pack design.

The plurality of electrode pairs are electrically connected in parallel to electrochemically store and release electric power. Each electrode pair includes an anode and a cathode with a separator disposed in between. Each anode has an anode current collector with a negative foil, and each cathode has a cathode current collector with a positive foil. The negative foils of the anodes of the plurality of electrode pairs are electrically connected in parallel and electrically connected to a negative terminal lead that protrudes through the pouch, and the positive foils of the cathodes of the plurality of electrode pairs are electrically connected in parallel, and electrically connected to a positive terminal lead that protrudes through the pouch.

Within each battery cell, the negative terminal lead electrically communicates with the negative current collectors that contact and exchange electrons with the negative electrodes of the electrode pairs, and the positive terminal lead electrically communicates with the positive current collectors that contact and exchange electrons with the positive electrodes of the electrode pairs. Lithium ion battery cells are capable of being discharged and re-charged over many cycles.

The negative foils of the anodes of the plurality of electrode pairs may be electrically connected in parallel and electrically connected to the negative terminal lead using laser welding, ultrasonic welding, or other methods too. Likewise, the positive foils of the anodes of the plurality of electrode pairs may be electrically connected in parallel and electrically connected to the positive terminal lead using laser welding.

Laser welding is a metal joining process in which a laser beam is directed at a stack of metal workpieces to provide a concentrated energy source capable of generating a fusion weld joint between the overlapping constituent metal workpieces. A laser beam is then directed at or near a top surface of the workpiece stack. The heat generated from the absorption of energy that is supplied by the laser beam initiates melting of the metal workpieces and establishes a molten weld pool within the workpiece stack. This molten weld pool solidifies to form a weld joint that is composed of re-solidified materials from all the layers of the metal workpieces.

Porosities and/or cracks are known to form along a laser weld fusion line of the foils due to many factors including surface conditions. Ultrasonic pre-welding of foils serves to consolidate the foils. Subsequently, laser welding of lead/foils aimed at the pre-welded locations can be used as the final weld. Localized material voids, which may be manifested as gaps between layers in the workpiece stack and/or as voids in one or more of the workpieces may affect quality of the weld joint, and hence affect service life of the component that includes the weld joint. When the workpiece stack includes a plurality of foils that are welded to a battery lead, the occurrence of localized material voids may compromise the strength of the weld joint and affect electrical conductivity between one or more of the foils and the battery lead.

It is therefore desirable to develop new methods for bonding battery foils to a lead or for bonding the foils together.

### SUMMARY

A method comprises deforming one or more metal foils of a battery between a punch and a die to form bent metal foils. The one or more bent metal foils are disposed in a foil holding fixture with a battery lead disposed next to the one or more bent metal foils such that a bent portion of the one or more bent metal foils are separated from the battery lead by a distance of 0.1 to 2 millimeters. The one or more bent metal foils are impact welded by causing the one or more bent metal foils to impact one another or to impact a battery lead at a velocity of speeds of 300 to 900 meters per second.

In an embodiment, one or more bent metal foils are supported on an anvil placed opposite the foil holding fixture.

In another embodiment, the battery lead is placed above the one or more bent metal foils in the foil holding fixture.

In yet another embodiment, the battery lead has a knurled surface and the knurled surface faces the one or more bent metal foils.

In yet another embodiment, opposing non-slidable surfaces of the punch and die are knurled and the one or more bent metal foils are crimped after the deforming.

In yet another embodiment, the impact welding occurs via explosion welding, magnetic pulse welding, vaporizing foil actuator welding, laser impact welding, or a combination thereof.

In yet another embodiment, the magnetic pulse welding comprises activating one or more electrical coils placed proximate to the one or more bent metal foils to enable the one or more bent metal foils to impact one another or to impact the battery lead. A coil holder that comprises the one or more electrical coils faces a first surface of the one or more bent metal foils, where the first surface is opposed to a second surface that faces the battery lead.

In yet another embodiment, the magnetic pulse welding comprises activating one or more electrical coils placed proximate to the one or more bent metal foils to enable the one or more bent metal foils to impact one another or to impact the battery lead. A coil holder that comprises the one or more electrical coils faces a first surface of the battery lead, where the first surface is opposed to a second surface of the battery lead that faces a first surface of the one or more bent metal foils.

In yet another embodiment, the punch is in slidable communication with the die.

In yet another embodiment, opposing non-slidable surfaces of the punch and die are provided with a mating male-female configuration.

In yet another embodiment, opposing non-slidable mating surfaces of the punch and die are flat.

In yet another embodiment, opposing non-slidable mating surfaces of the punch and die are curved.

In yet another embodiment, the one or more battery foils are heated prior to or during the deforming, wherein the heating is conducted via resistive heating, infrared heating, laser heating, or a combination thereof.

In yet another embodiment, opposing non-slidable mating surfaces of the punch and die are heated by inductive heating, resistive heating, or a combination thereof.

A device for bending one or more battery metal foils comprises a punch; and a die; wherein the punch and die are in slidable communication with one another. Opposing non-slidable mating surfaces of the punch and die are knurled. The opposing non-slidable mating surfaces of the punch and die are heated by inductive heating, resistive heating, or a combination thereof. The punch and die are operative to bend one or more bent metal foils to produce an indentation having a height of 0.1 to 2 millimeters.

In an embodiment, opposing non-slidable mating surfaces of the punch and die are curved.

In another embodiment, the curved surfaces are hemispherical or semi-cylindrical.

A device for impact welding one or more bent metal foils comprising an anvil and a coil holder that contains electrical coils. The anvil is operative to support a battery lead and/or one or more bent metal foils. The electrical coils are operative to facilitate an impact between the one or more bent metal foils with each other or between the one or more bent metal foils and the battery lead. The one or more bent metal foils are separated from the battery lead by a distance of 0.1 to 2 millimeters.

In an embodiment, the impact produces a bond between the one or more bent metal foils or between the one or more bent foils and the battery lead.

In an embodiment, the anvil contacts a side of the one or more bent metal foils that is opposed to a side that contacts the battery lead.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an exemplary depiction of a battery;

FIG. 2 depicts one aspect of a punch and die for shaping the foils of a battery (not shown) prior to welding the foils with each other and to the battery cell lead;

FIG. 3 depicts another aspect of a punch and die for shaping the foils of a battery (not shown) prior to welding the foils with each other and to the battery cell lead;

FIG. 4 depicts another aspect of a punch and die for shaping the foils of a battery by using induction heating;

FIG. 5 depicts another aspect of a punch and die for shaping the foils of a battery by using resistive heating; and

FIG. 6 is a process flow diagram depicting the process of impacting welding the bent metal foils.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Disclosed herein is a forming device that comprises a punch and die that can be used to deform one or more battery foils to create a gap between a battery foils and a battery lead so that they can be impact welded together. The deforming is also referred to herein as bending. The gap can be used in an impact welding operation to promote an increase in velocity between the battery foils and the battery lead when the battery foils are energized. This energization is sometimes referred to as a “driving force”. The driving force increases velocity of the foils towards the lead which in turn facilitates an impact between the foils and the lead bringing about a weld between the foils themselves as well as between the foils and the lead. The gap provides the foils with the distance desirable for increasing their velocity (during energization) so that they can impact one another or a battery lead with sufficient force or momentum so as bring about bonding.

The foils may be referred to as a flyer (because they move towards the lead upon being energized) and the lead is referred to as the target. Impact welding encompasses different welding processes, such as explosion welding (EXW), magnetic pulse welding (MPW), vaporizing foil actuator welding (VFAW), laser impact welding (LIW), or a combination thereof. In an exemplary embodiment, the impact welding is brought about by magnetic pulse welding.

During the bending, the foils and the tab may be interlocked (also sometimes termed crimping) and bonded together by using a punch and die with opposing surfaces that are knurled. Interlocking refers primarily to mechanical interlocking that occurs when the mating surfaces are roughened by contact with a knurled deforming force. In this case, the battery foils may be deformed by a punch and die that have knurled surfaces. This deforming causes the battery foil surfaces to get roughened and consequently interlock mechanically with one another because of the surface roughness.

Bonding refers to contact between two surfaces where there may be chemical diffusion from one mating surface into an opposing contacting surface. For example, when the battery foils are bonded together, ingredients from one foil can diffuse into a neighboring foil. Bonding typically occurs when there is an increase in temperature during the contact between the two opposing contacting surfaces. For example, if the opposing surfaces are knurled at an elevated temperature (at or above a metal softening point) the opposing surfaces can be interlocked and bonded. If the temperature during knurling is not increased to about the metal softening point, then the opposing surfaces will most likely be interlocked but not bonded.

Disclosed herein too is a welding device and a method of performing impact welding to bond together the metal foils of a battery and/or to bond the metal foils to the battery lead. In an embodiment, the battery can be a lithium ion battery. The method comprises bringing the bent battery foils in proximity to a battery lead and energizing the bent foils via an electrical current that is discharged through magnetic coils. This energization causes the battery foils to accelerate across the gap (created by the bending) and to impact the battery lead with a force sufficient to bring about welding of the battery foils with one another or with the battery lead. The battery foils and the battery lead may be independently heated during this welding process bringing about bonding.

Prior to describing the device and the method for magnetically welding the foils of a battery, a brief introduction to the relevant parts of a battery is presented in order to enhance an understanding of this disclosure.

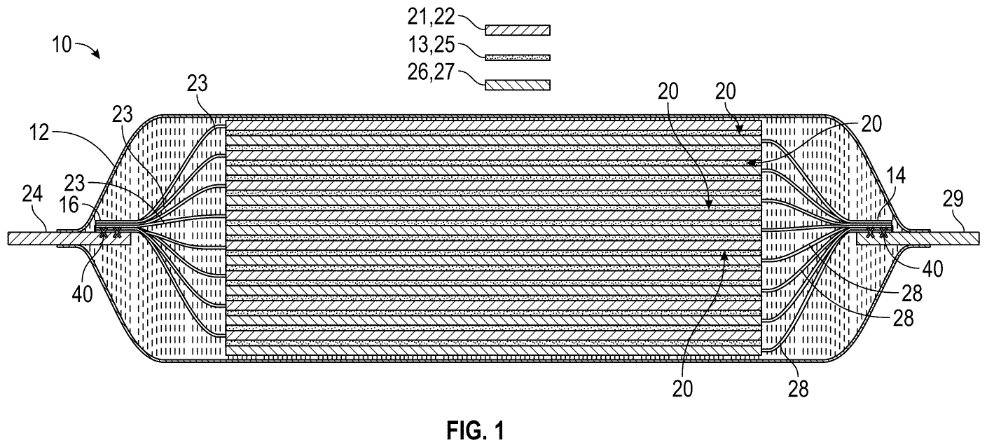

Referring to the drawings, FIG. 1 schematically illustrates an embodiment of a prismatically-shaped lithium ion battery cell 10 that includes a plurality of electrode pairs 20 that are arranged in a stack and sealed in a flexible pouch 12 containing an electrolytic material 13. A first, positive battery cell lead 29 and a second, negative battery cell lead 24 protrude from the flexible pouch 12. Each of the electrode pairs 20 includes an anode 21 arranged on an anode (or negative) current collector 22, and a cathode 26 arranged on a cathode (or positive) current collector 27 and are separated by a separator 25. The cathode current collector 27 is fabricated from aluminum or an aluminum alloy and includes a positive foil (or cathode foil) 28. The anode current collector 22 is fabricated from copper, a copper alloy, or another material, and includes a negative foil (or anode foil) 23.

The negative and positive current collectors 22, 27 are thin metallic plates that contact their respective negative and positive electrodes 21, 26 over an appreciable interfacial surface area. The purpose of these metal current collectors 22, 27 is to exchange free electrons with their respective negative and positive electrodes 21, 26 during discharging and charging of the electrode pairs 20. To facilitate the collective distribution and flow of electrons, each of the negative current collectors 22 includes the negative foil 23, and each of the positive current collectors 27 includes the positive foil 28.

The plurality of negative foils 23 protrude away from the electrode pairs 20 and are positioned in overlapping alignment with one another, and the plurality of positive foils 28 also protrude away from the electrode pairs 20 and are positioned in an overlapping alignment with one another. The aligned sets of negative and positive foils 23, 28 are separated from each other either on different sides of the electrode pairs 20 (as shown) or are on the same side of the electrode pairs 20 (not shown). The plurality of positive foils 28 of the cathode current collectors 27 are arranged in a first stack 14 and are electrically coupled and mechanically joined to the positive battery cell lead 29 in a manner that is described herein. The plurality of negative foils 23 of the anode current collectors 22 are arranged in a second stack 16 and are electrically coupled and mechanically joined to the second, negative battery cell lead 24.

Each of the electrode pairs 20 includes a positive electrode (or cathode) 26, a negative electrode (or anode) 21, and a separator 25 disposed between the positive and negative electrodes 26, 21 to physically separate and electrically insulate the positive and negative electrodes 26, 21 from each other. The electrolytic material 13 that conducts lithium ions is contained within the separator 25 and is exposed to each of the positive and negative electrodes 26, 21 to permit lithium ions to move between the positive and negative electrodes 26, 21.

The device and the method disclosed herein is used to bond together the plurality of positive foils 28 to form the first stack 14 and the plurality of negative foils 23 to form the second stack 16. The use of impact welding has some significant advantages over other known methods—notably that it can be used to bond dissimilar metals, be used to bond metals with oxide coatings and contaminants without any adverse effects to the battery.

As noted above, impact welding uses a driving force and a proper gap (between the flyer and the target) to create a solid-state weld at about room temperature. This weld is completed in microseconds and may be stronger than the base metals joined.

In magnetic pulse welding, the conductive workpiece is placed inside or next to an electrical coil which accelerates it over a distance to impact the second workpiece at extremely high speed. A large amount of energy in the form of an electrical current is discharged in an extremely short period of time through the coil. Some systems can discharge up to 2 million amps in less than or equal to 100 microseconds. The acceleration is a result of repelling magnetic fields between the workpiece and the coil, produced by eddy currents in the workpiece. The reaction forces between the opposing magnetic fields force the workpieces towards each other at high velocity to cause welding. The impacting speed is typically 300-900 m/s. A preferred form of impact welding is magnetic impact welding.

A solid state weld is created when two metals are forced together in such intensity that their atoms start sharing electrons, practically bonding the two metals together. The actual process lasts no longer than 100 microseconds. Since there is no heat or melting involved, dissimilar metals can be welded using this technique. Impact welding triggers this phenomenon by accelerating the metal into a visco-plastic phase and impacting the other workpiece to bring about bonding. No protecting atmosphere, filler materials or other aiding materials are used in this bonding process. The magnetic pulse welding process is a “cold” or at most a “warm” welding process; the temperature is significantly lower than the melting temperature of the metals. Due to this, no fusion zone is created. The weld can be the strongest part of the assembly. Impact welding is highly repeatable, reproducible, and reliable and therefore well suited to high-volume production. Many welding combinations using dissimilar metals are possible. It is a weld with no heat-affected zone. The bond between the different metals is of a high quality, very aesthetic and produces a cleaner interface. The bond maintains a mechanical strength (typical joints can be stronger than the parent material). All of these advantages translate into significantly lower costs and much higher quality and productivity.

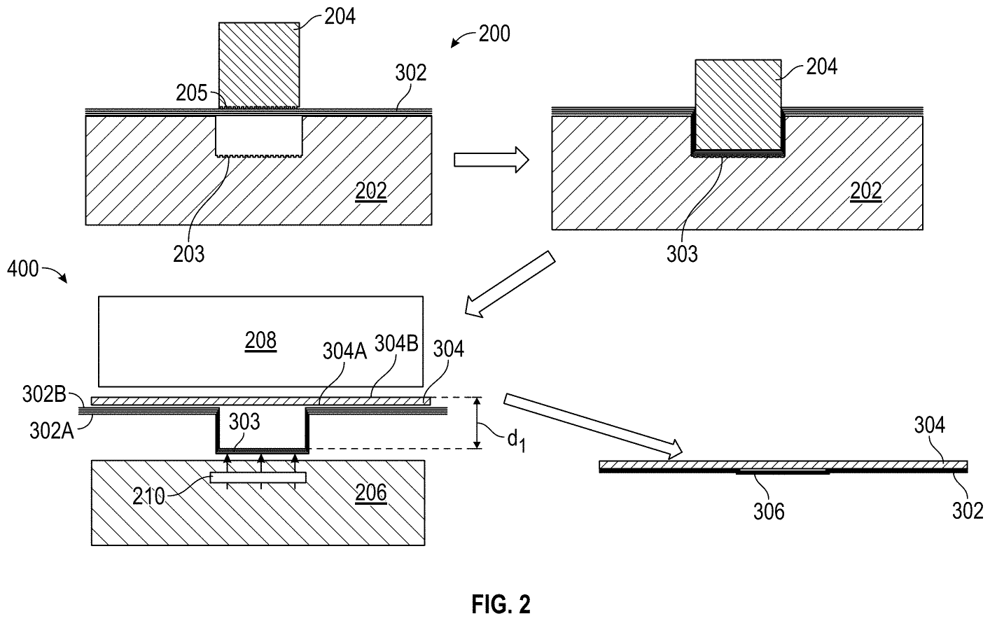

FIG. 2 depicts one aspect of a forming device 200 for shaping (also bending) the foils 302 of a battery (not shown) prior to welding the foils with each other and to the battery cell lead 304. The battery may have one or more metal foils. While in this document, the foils are sometimes referred to as a plurality of foils, it is to be understood that the battery can have a single foil or multiple foils. When the battery has a single foil, it is welded to the battery lead. Alternatively, when the battery comprises multiple foils, the foils can be welded to each other and to the battery lead. These foils are referred to herein as metal foils.

The battery cell lead 304 (also referred to as battery lead 304) generally comprises copper or aluminum. In an embodiment, the surface of the battery lead 304 is knurled (or has surface texture/projections) to further enhance the welding quality between the lead and the foils that are disposed on it. The knurling of the battery lead produces a surface roughness which increases gaps between the lead 304 and the closest foil (of the plurality of bent foils 302), which permits an acceleration of the foils when subjected to opposing magnetic fields. The gap provides the bent foils 302 with space in which to accelerate towards the lead 304 and weld with it upon impacting it. This permits a good weld between the bent foils 302 and the battery lead 304.

The forming device 200 comprises a punch 204 and a die 202 that are in slidable communication with each other. In other words, the punch 204 can engage with the die 202 to bend the metal foils 302 of the battery when the metal foils are located between the punch and the die 202. The first surface 203 of the punch 204 that contacts the opposing first surface 205 of the die 202 are both knurled. The knurled first surface 203 and the knurled opposing first surface 205 promote adhesion and generate interlocking between the foils when they are compressed between the punch 204 and the die 202. The knurling improves interlocking and bonding between the foils.

The metal foils 302 generally have an individual thickness of 6 to 16 micrometers each. A stack generally comprises 6 to 240 metal foils. After the metal foils 302 are placed between the punch 204 and the die 202, the punch 204 is moved towards the die 202. Compressive forces are applied to the metal foils 302 via the punch 204. The metal foils 302 are deformed (e.g., bent) to take a shape determined by the shape of the opposing faces of the punch 205 and die 203. During bending, the knurled surfaces 205 and 203 of the punch and the die respectively promote interlocking and bonding of the metal foils and bring about an increased surface area contact between the metal foils 302 of the battery. After the bending of the metal foils, the punch is moved away from the die and a new set of metal foils may be placed in the space between the punch and die. The process is repeated to produce another set of bent metal foils 303.

After the bending of the metal foils, the bent metal foils 303 are subjected to impact welding in a welding device 400 that comprises an anvil 208 and a coil holder 206. The anvil 208 provides physical support to the battery lead 304 during the impact welding process. The coil holder 206 is manufactured from an electrically insulating material and contains one or more magnetic coils 210 that causes the bent metal foils 303 to contact the battery lead 304 at a high velocity.

In one method of operating the welding device 400, a battery lead 304 is disposed on the bent foils 303. The battery lead 304 has a thickness of 0.1 to 0.6 millimeters. An anvil 208 is disposed on the battery lead 304. The coil holder 206 containing a magnetic coil 210 is then brought proximate to the bent metal foils 303 and the battery lead 304. The bent metal foils 303 are located on an opposing side of the battery lead 304 from the anvil 208.

In other words, with reference to FIG. 2, the coil holder 206 faces a first surface 302A of the bent metal foils 303. The second surface 302B of the bent metal foils (that is opposed to the first surface of the bent metal foils 303) faces a first surface 304A of the battery lead 304. The second surface 304B of the battery lead 304 (which is opposed to the first surface 304A of the battery lead 304) faces the anvil 208. In another embodiment (not shown in the FIG. 2), the battery lead 304 and the bent metal foils 303 may exchange positions such that a first surface 304A of the battery lead 304 faces the coil holder 206, while the opposing second surface 304B faces a first surface 302A of the battery foils. The second surface 302B of the battery foils faces the anvil 208.

The coil 210 is electrically activated (a current is allowed to flow through the coils) which creates a magnetic force that causes the foils 303 to contact the lead 304 at a high velocity. Electrically insulating materials can be polymers or ceramics. The distance between the bent metal foils 303 and the lead 304 is shown as di in the FIG. 2. It is desirable for di to be 0.1 to 2.0 millimeters. In other words, the punch and die produce an indentation having a height (di) of 0.1 to 2 millimeters in the metal foils. This distance permits the bent metal foils 303 to impact the lead 304 with sufficient velocity, force and momentum (upon being activated) to bring about a successful bond with the lead 304.

In an embodiment, the welding device 400 can comprise a clamp (not shown) to press down on the bent foils and bring them into contact with the battery lead or alternatively, as close to the battery lead 304 as possible. In an embodiment, a coil holder (containing a plurality of coils) (not shown) may be moved into position such that each coil of the plurality of coils lies directly above the bent portion of a battery foil (when the battery foil contains a plurality of bent portions) (not shown). The plurality of coils are then energized using an electrical current. The opposing magnetic fields cause the foils to be accelerated towards each other and impact one another to bond together. In an embodiment, the foils are accelerated towards the lead to bond with the lead forming a weld 306.

It is to be noted that while the coil holder 206 shown in the FIG. 2 displays a single coil 210, the coil holder can contain a plurality of coils (not shown) each of which can be located adjacent a bent portion of the battery foils. The plurality of coils can all be activated simultaneously or sequentially to facilitate contact between the foils and the lead, thus bringing about welding. The coil(s) can be connected to a source of electrical power (not shown).

In an embodiment, during the welding process in the device 400, the bent foils and the battery lead may be independently heated prior to or during the impact welding process. Such independent heating may be brought about by infrared heating, convective heating, laser heat, or the like, or a combination thereof. Such heating may facilitate bonding of the bent foils to each other or to the battery lead.

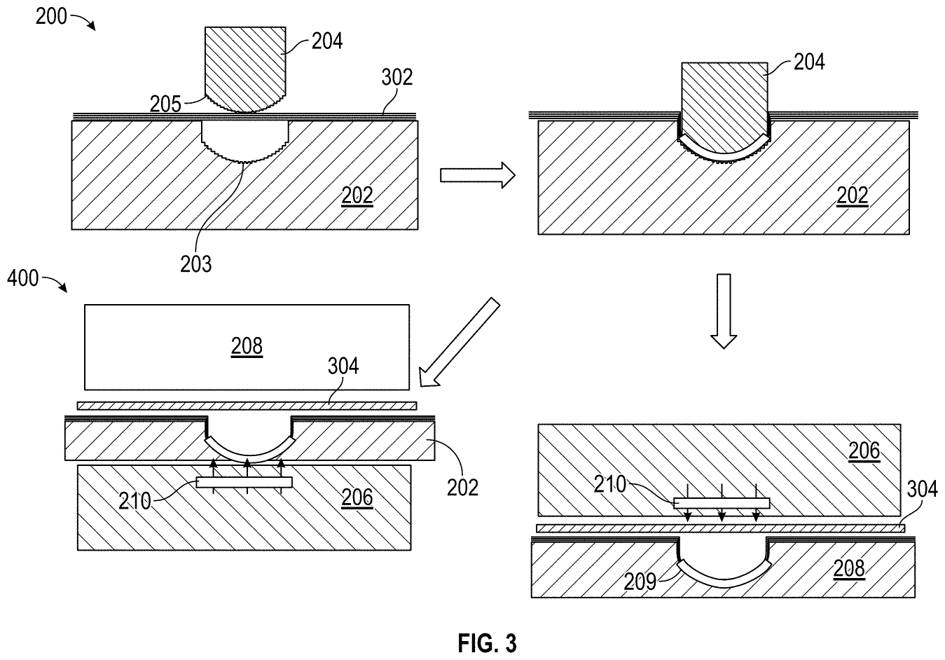

FIG. 3 depicts another aspect of a forming device 200 that comprises a punch 204 and die 202 for bending the foils 302 of a battery (not shown) prior to welding the foils 302 with each other and to the battery cell lead 304 (in the welding device 400). The punch 204 and the die 202 are once again in slidable communication with one another. In this case the opposing surfaces 205 and 203 of the punch 204 and die 202 respectively are hemispherical or semi-cylindrical and are arranged in a male-female mating configuration. For example, surface 205 can protrude into surface 203 (or vice-versa) and can bend the plurality of metal foils causing them to be interlocked and bonded. When surface 205 is provided with the male configuration, it protrudes into surface 203, which is provided with the female configuration. Alternatively, when surface 203 is provided with the female configuration, it protrudes into surface 205, which is provided with the male configuration.

The opposing surfaces 205 and 203 (which are in non-slidable communication with each other) mate with each other and can be knurled. As discussed in the FIG. 2, the punch 204 can engage with the die 202 to bend the metal foils 302 of the battery when the metal foils are located between the punch and the die 202.

The knurled first surface 205 and the knurled opposing first surface 203 promotes interlocking and bonding between the foils when they are compressed between the punch 204 and the die 202.

FIG. 3 also depicts the welding device 400 that comprises the anvil 208 that supports the battery lead 304 and the plurality of battery foils 302 during the impact welding. A coil holder 206 which contains and electrical coil 210 may be positioned beneath the bent foils or above them during the generation of a magnetic pulse which causes welding in the foils 302 as well as welding of the battery foils 302 to the lead 304. The function of the anvil and the coil holder are detailed above and will not be detailed again.

FIG. 3 depicts two embodiments of how the anvil 208 and the coil holder 206 may be used. In one embodiment (seen on the bottom left of the FIG. 3), the coil holder 206 is placed on one side of the bent foils 302, while the battery lead 304 lies on the opposite side of the bent foils 302. An anvil that supports the battery lead 304 lies on the side of the battery lead opposite from the side that faces the bent foils 302. In the other embodiment (seen on the bottom right of the FIG. 3) the coil holder 206 lies on the upper side of the battery lead 304 while the bent battery foils 302 lie on the lower side of the battery lead 304. An anvil 208 with a surface 209 that can accommodate the bent foils 302 is used to support the foils during the impact welding process.

In short, the anvil and the coil holder of the FIG. 3 can reverse positions around the bent foils and the lead. When the anvil is located next to the battery lead, the coil holder is located next to the bent foils and vice versa, while the battery lead and the bent foils are always located directly next to each other.

In both of these embodiments (that depicted on the lower left side and that on the lower right side of the FIG. 3), the activation of the coil(s) in the coil holder promotes movement of the bent foils towards the battery lead bringing about welding.

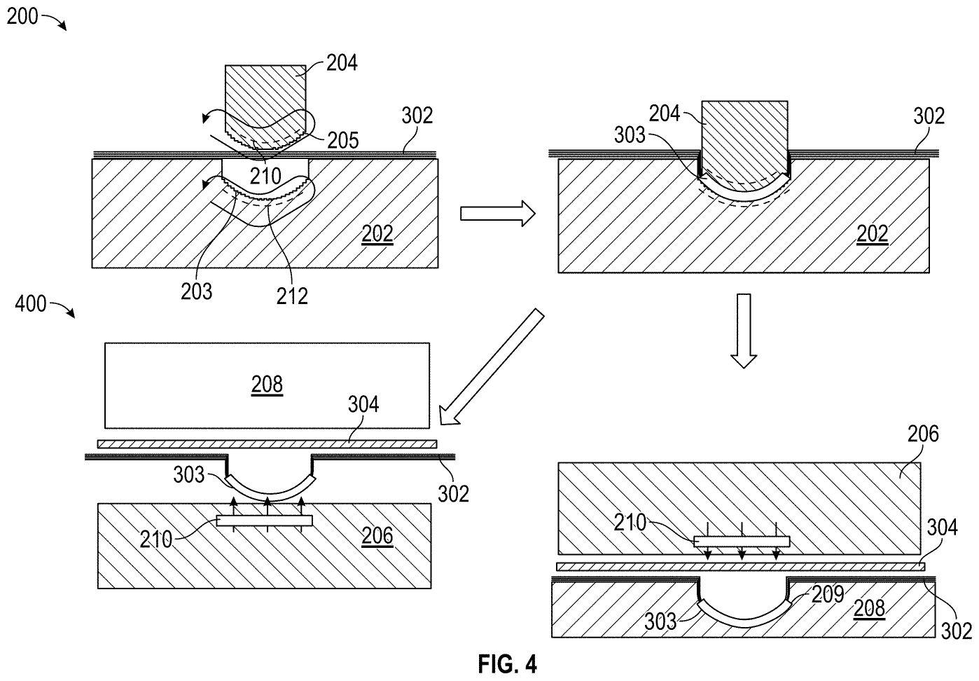

FIG. 4 is another exemplary depiction of a forming device 200 where the punch 204 and die 202 (which are in slidable communication with each other) are provided with induction coils 210 and 212 respectively to heat the punch and die. The induction coils 210 and 212 are located proximate the opposing mating surfaces 205 and 203 respectively and heat the metal foils via induction heating. Induction heating is the process of heating materials (e.g., metals) by electromagnetic induction. An induction heater consists of an electromagnet (not shown) and an electronic oscillator (not shown) that passes a high-frequency alternating current (AC) through the electromagnet. The rapidly alternating magnetic field penetrates the object, generating electric currents inside the conductor, called eddy currents. The eddy currents flow through the resistance of the material and heat it by Joule heating.

Induction heating is used to heat the opposing mating surfaces 205 and 203 to soften the metal foils 302 disposed between the punch and die to produce the bent metal foils 303. The punch and die impose compressive forces to effect the bonding and interlocking of the metal foils during the induction heating process.

The opposing surfaces 205 and 203 of the punch 204 and die 202 may be flat (as seen in the FIG. 2) or may be hemispherical or semi-cylindrical (as seen in the FIG. 4) and are arranged in a male-female mating configuration as detailed above in the FIG. 3. The opposing mating surfaces 205 and 203 may be knurled.

After the forming of the bent metal foils 303, they may be disposed in the welding device 400 adjacent to a battery lead 304 and subjected to a magnetic force (via the coil holder 206 that contains coil 210) to facilitate bonding of the metal foils to each other and to the lead. This process has been detailed in the FIG. 2 and will not be repeated in the interests of brevity.

As seen previously in the FIG. 3, the anvil and the coil holder of the FIG. 4 can reverse positions around the bent foils and the lead. When the anvil is located next to the battery lead, the coil holder is located next to the bent foils and vice versa.

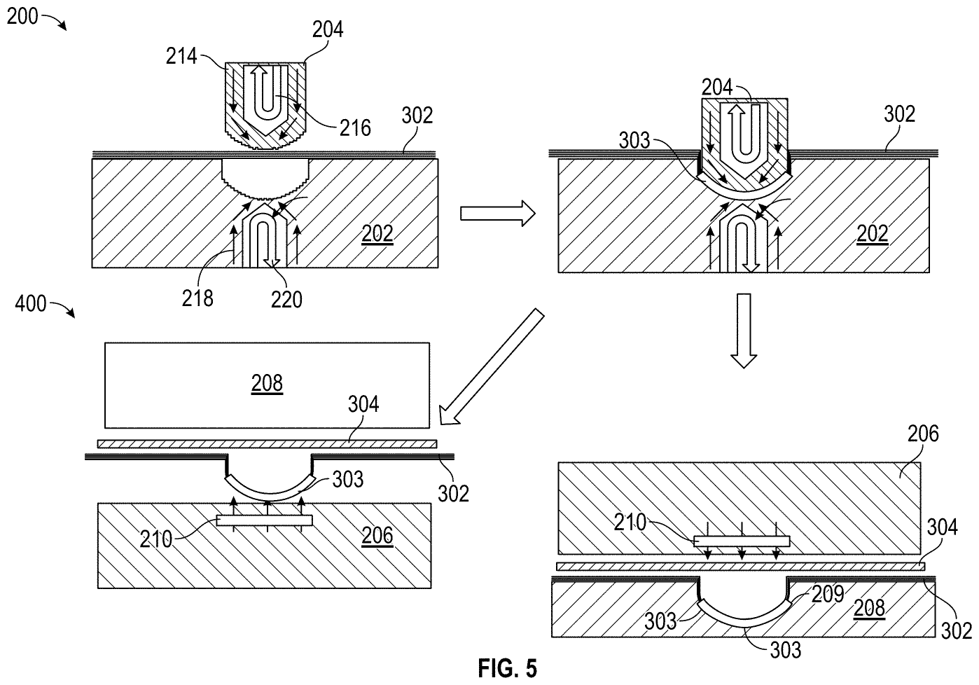

FIG. 5 is another exemplary method of forming the battery metal foils 302 using a forming device 200 that comprises the punch 204 and die 202 both of which are heated by resistive heating. In this instance, both the punch 204 and die 202 are provided with electrical coils (214 and 218 respectively) and cooling systems (216 and 220 respectively). The electrical coils 214 and 218 heat the surfaces of the punch and die respectively via conduction (the heat being derived from the resistive heating of the coils 214 and 218). The cooling system may use cooling water to control the heat generated at the surfaces of the punch and die and maintain the punch and die at a desired temperature.

Heat generated by the electrical coils 214 and 218 are used to heat the opposing mating surfaces 205 and 203 to soften the metal foils 302 disposed between the punch and die to produce the bent metal foils 303. The punch and die impose compressive forces on the metal foils to effect the bonding and interlocking of the metal foils during the induction heating process.

The opposing surfaces 205 and 203 of the punch 204 and die 202 may be flat (as seen in the FIG. 2) or may be hemispherical or semi-cylindrical (as seen in the FIG. 5) and are arranged in a male-female mating configuration as detailed above in the FIG. 3. The opposing mating surfaces 205 and 203 may be knurled. After the bending of the metal foils 303, they may be disposed in the welding device 400 adjacent to a battery lead 304 and subjected to a magnetic force via coil 210 (contained in coil holder 206) to facilitate bonding of the metal foils to each other and to the lead. This process has been detailed in the FIG. 2 and will not be repeated in the interests of brevity. As in the FIGS. 3 and 4, the anvil 208 and the coil holder 206 can exchange positions around the bent metal foils and the battery lead. When the anvil is located next to the battery lead, the coil holder is located next to the bent foils and vice versa.

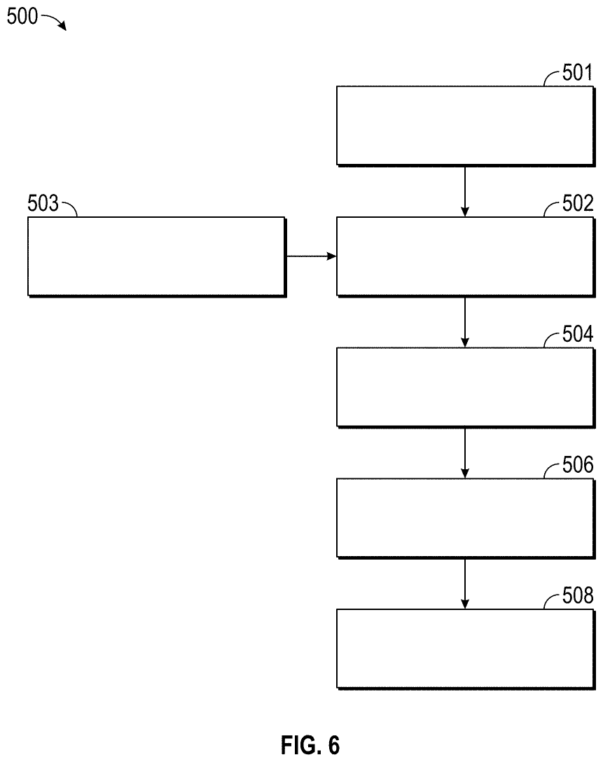

FIG. 6 depicts a process 500 for impact welding the battery foils with the battery lead. In step 502 the battery foils are disposed between punch and die and deformed to form the bent metal foils. The battery foils may be optionally heated (step 501) prior to or optionally during (step 503) the process of deforming the foils. The bent metal foils are then disposed next to a battery lead (step 504). The battery lead along with the adjacent battery foils are then disposed between the coil holder and the anvil (step 506). The coils in the coil holder are activated (step 508) to promote impact between the foils themselves or between the foils and the lead thus bringing about welding.

The process of bonding foils together or of bonding foils to the lead using magnetic welding is advantageous because dissimilar metals may be bonded together. Contaminants do not disrupt or weaken the bond. The method can be a viable alternative welding process to replace 2-step ultrasonic/ultrasonic or ultrasonic/laser welding for batteries, which sometimes causes battery failure. The method also enables dissimilar metals bonding to reduce defects (intermetallic compounds, porosity and thermal cracking), and to be more tolerant to surface oxides/contaminations.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method comprising:
deforming one or more metal foils of a battery between a punch and a die to form bent metal foils;
disposing the one or more bent metal foils in a foil holding fixture;
disposing a battery lead next to the one or more bent metal foils such that a bent portion of the one or more bent metal foils is separated from the battery lead by a distance of 0.1 to 2 millimeters; and
impact welding the one or more bent metal foils by causing the foils to impact one another or to impact a battery lead at a velocity of speeds of 300 to 900 meters per second.

2. The method of claim 1, further comprising supporting the one or more bent metal foils on an anvil in the foil holding fixture.

3. The method of claim 1, further comprising placing the battery lead above the one or more bent metal foils in the foil holding fixture.

4. The method of claim 3, where the battery lead has a knurled surface and wherein the knurled surface faces the one or more bent metal foils.

5. The method of claim 1, wherein opposing non-slidable surfaces of the punch and die are knurled and wherein the bent metal foils are crimped after the deforming.

6. The method of claim 1, wherein the impact welding occurs via explosion welding, magnetic pulse welding, vaporizing foil actuator welding, laser impact welding, or a combination thereof.

7. The method of claim 6, wherein the magnetic pulse welding comprises activating one or more electrical coils placed proximate to the one or more bent metal foils to enable the one or more bent metal foils to impact one another or to impact the battery lead; wherein a coil holder that comprises the one or more electrical coils faces a first surface of the one or more bent metal foils; wherein the first surface is opposed to a second surface that faces the battery lead.

8. The method of claim 6, wherein the magnetic pulse welding comprises activating one or more electrical coils placed proximate to the one or more bent metal foils to enable the one or more bent metal foils to impact one another or to impact the battery lead; where a coil holder that comprises the one or more electrical coils faces a first surface of the battery lead; wherein the first surface is opposed to a second surface of the battery lead that faces a first surface of the one or more bent metal foils.

9. The method of claim 1, wherein the punch is in slidable communication with the die.

10. The method of claim 1, wherein opposing non-slidable surfaces of the punch and die are provided with a mating male-female configuration.

11. The method of claim 1, wherein opposing non-slidable mating surfaces of the punch and die are flat.

12. The method of claim 1, wherein opposing non-slidable mating surfaces of the punch and die are curved.

13. The method of claim 1, further comprising heating the battery foils prior to and/or during the deforming, wherein the heating is conducted via resistive heating, infrared heating, laser heating, or a combination thereof.

14. The method of claim 12, wherein opposing non-slidable mating surfaces of the punch and die are heated by inductive heating, resistive heating, or a combination thereof.

15. A device for bending battery metal foils comprising:
a punch; and
a die; wherein the punch and die are in slidable communication with one another; wherein opposing non-slidable mating surfaces of the punch and die are knurled; wherein the opposing non-slidable mating surfaces of the punch and die are heated by inductive heating, resistive heating, or a combination thereof; wherein the punch and die are operative to bend one or more electrical foils to produce an indentation having a height of 0.1 to 2 millimeters.

16. The device of claim 15, wherein the opposing non-slidable mating surfaces of the punch and die are curved.

17. The device of claim 16, wherein the curved surfaces are hemispherical or semi-cylindrical.

18. A device for impact welding one or more bent metal foils comprising:
an anvil; wherein the anvil is operative to support a battery lead and/or the one or more bent metal foils; and
a coil holder that contains electrical coils; wherein the electrical coils are operative to facilitate an impact between the one or more bent metal foils with each other or between the one or more bent metal foils and the battery lead; wherein the one or more bent metal foils are separated from the battery lead by a distance of 0.1 to 2 millimeters.

19. The device of claim 18, wherein the impact produces a bond between the one or more bent metal foils or between the one or more bent metal foils and the battery lead.

20. The device of claim 18, wherein the anvil contacts a side of the one or more bent metal foils that is opposed to a side that contacts the battery lead.
